(19) United States
(12) Patent Application Publication
(10) Pub. No.: US 2026/0005597 A1
(43) Pub. Date: Jan. 1, 2026

(54) SWITCH CONTROL AND REDUCTION IN POWER CONSUMPTION

(71) Applicant: Infineon Technologies Austria AG, Villach (AT)

(72) Inventors: Thomas FERIANZ, Bodensdorf (AT); Diego DIAS DE MENEZES, Villach (AT)

(21) Appl. No.: 18/758,308

(22) Filed: Jun. 28, 2024

(51) Int. Cl. H02M 1/08; H02M 3/158

(52) U.S. Cl. CPC H02M 1/08; H02M 3/158

(57) ABSTRACT

A power converter assembly as discussed herein can be configured to include: a first input operative to receive a first control signal indicating how to control a main switch; switch driver circuitry operative to convert the first control signal into a second control signal; and an output operative to output the second control signal to the main switch, the second control signal including first current supplied from a first current source of the switch driver circuitry to the main switch, a magnitude of the first current varying based on a voltage magnitude of the second control signal.

### BACKGROUND

Conventional switch driver circuitry can be configured to receive a primary control signal from a controller and convert it into a secondary control signal applied to a respective switch to control its operation.

One reason for switch driver circuitry is to isolate the controller from the switch as well as to properly drive a respective control input of the switch. For example, the controller may be configured to operate in a first voltage range. The respective switch may be required to operate in a second voltage range different than the first voltage range. In certain instances, switches such as GaN (Gallium Nitride) field effect transistors require special drive signals to maintain the switch to an ON-state or OFF-state.

Conventional solutions of driving a respective GaN field effect transistor such as those using RC network may overcharge the GaN gate of the field effect transistor, like the RC network, and others may rely solely on the reaction time of a respective driver circuitry sensing the GaN power switch Vgs to minimize gate overcharging.

### BRIEF DESCRIPTION

Implementation of clean energy (or green technology) is very important to reduce our impact as humans on the environment. In general, clean energy includes any evolving methods and materials to reduce an overall toxicity to the environment as caused by energy consumption.

This disclosure includes the observation that a desirable aspect of a switch driver circuit is to achieve better power efficiency when controlling respective switches. For example, a certain amount of power is dissipated by merely turning on and off a respective switch. Implementation of efficient switch driver circuitry reduces a respective amount of power consumed turn on and off a respective switch.

More specifically, a power converter assembly as discussed herein can be configured to include: a first input operative to receive a first control signal indicating how to control a main switch; switch driver circuitry operative to convert the first control signal into a second control signal; and an output operative to output the second control signal to the main switch, the second control signal including first current supplied from a first current source of the switch driver circuitry to the main switch, a magnitude of the first current varying based on a voltage magnitude of the second control signal.

In one example, the first current source may be or include a field effect transistor that outputs the first current to a gate node of the main switch. Output of the first current increases a magnitude of the voltage applied to the gate node of the main switch. The increased magnitude of the voltage applied to the gate node of the main switch results in self turn off or an increase in resistance of the switch. The increased resistance reduces a magnitude of the first current supplied to the gate node of the main switch as further discussed herein.

The first current source may be or include a field effect transistor including a source node operative to output the first current to a gate node of the main switch. A supply of the first current (and control of same) from the source node of the field effect transistor to the gate node of the main switch can be configured to reduce a magnitude of the first current over time. For example, the magnitude of the first current can be configured to decrease over time in response to an increase in an RDS on resistance between a drain node of the field effect transistor and the source node of the field effect transistor. The RDS on resistance between the drain node of the field effect transistor and the source node of the field effect transistor increases during operation in response to a decrease in a gate-to-source voltage between a gate node of the field effect transistor and the source node of the field effect transistor, the decrease occurring in response to an increase in the voltage magnitude of the second control signal (such as applied to a gate node of the main switch) over time.

Note further that the apparatus as discussed herein can be configured to include a second current source operative to produce second current, the second current source disposed in parallel with the first current source, the second control signal including a combination of the first current and the second current; and wherein the second control signal may be applied to a gate node of the main switch to control the main switch. The first control signal such as from a controller or other suitable entity to the may indicate to activate the main switch for a time duration. Yet further, the first current source can be configured to: i) supply the first current to the gate node of the main switch for a first portion of the time duration, and ii) discontinue supply of the first current to the gate node of the main switch for a second portion of the time duration, the second portion following the first portion. The second current source can be configured to supply the second current to the gate node of the main switch for both the first portion of the time duration and the second portion of the time duration; and wherein output of the second control signal for the entire time duration to the gate node can be configured to maintain the main switch in an ON-state for the time duration.

A magnitude of the first current at an end of the first portion of the time duration can be configured to maintain the main switch to an ON-state.

In yet further examples as discussed herein, the first current source may be or include a field effect transistor operative to supply the first current from a source node of the field effect transistor to a gate node of the main switch. The first current supplied by the field effect transistor to the gate node of the main switch increases the voltage magnitude of the second control signal supplied to the gate node of the main switch. The field effect transistor may be an N-type field effect transistor or other suitable entity. The increase in the voltage magnitude of the second control signal applied to the gate node of the main switch can be configured to reduce a gate-to-source voltage between a gate node of the field effect transistor and the source node of the field effect transistor, the reduced gate-to-source voltage operative to reduce the magnitude of the first current supplied from the source node of the field effect transistor to the main switch.

The main switch can be implemented and/or fabricated in any suitable manner. In one example, the main switch may be fabricated from Gallium Nitride (GaN). In one example, the main switch as discussed herein may be a GaN device, or more specifically, a GaN Gate Injection Transistor (GIT) device.

Yet further examples as discussed herein include implementation of the apparatus to include: a second input operative to receive feedback tracking the voltage magnitude of the second control signal (the feedback may be the second control signal itself); a comparator operative to compare the received feedback (such as the second control signal applied to the gate node of the main switch) to a threshold level; and a signal generator operative to terminate activation of the first current source supplying the first current to the main switch in response to detecting that the feedback crosses or is greater than or less than the threshold level.

In accordance with further examples as discussed herein, the apparatus can be configured to include a first switch connected between a gate node of the main switch and a source node of the main switch, the first switch operative to short the gate node of the main switch to the source node of the main switch during startup of the switch driver circuitry to prevent activation of the main switch when the power used to power the switch driver circuitry is less than a threshold level.

Note further that the first current source can be configured in any suitable manner. In one example, as previously discussed, the first current source is one may include a first field effect transistor. The switch driver circuitry also can be further configured to include a second field effect transistor operative to convey a control voltage (trimmed voltage) received from a trimmable voltage source to a control input of the first field effect transistor to activate the first field effect transistor. A magnitude of the control voltage received from the trimmable voltage source may be selected to limit the magnitude of the first current supplied by the first current source to the main switch. The selected current limit (as implemented by the voltage supplied by the trimmable voltage source) may be based on a magnitude of the first current required to drive a gate node of the main switch to activate the main switch to an ON-state.

Additionally, note that although examples as discussed herein are applicable to switch driver applications and respective control of switch circuitry, the concepts disclosed herein may be advantageously applied to any other suitable topologies as well as general power supply control applications.

In a further example, techniques herein include a method comprising: via a first input of switch driver circuitry, receiving a first control signal indicating how to control a main switch; via the switch driver circuitry, converting the first control signal into a second control signal; and via an output of the switch driver circuitry, outputting the second control signal to the main switch, the second control signal including first current supplied from a first current source of the switch driver circuitry to the main switch, a magnitude of the first current varying based on a voltage magnitude of the second control signal.

The ordering of the steps above has been added for clarity sake. Note that any of the processing operations as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be implemented strictly as a software program, firmware, as a hybrid of software, hardware and/or firmware, or as hardware alone such as within a processor (hardware or software), or within an operating system or a within a software application.

As discussed herein, techniques herein are well suited for use in the field of implementing one or more power converters to deliver current to a load. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram of circuitry including switch driver circuitry as discussed herein.

FIG. 2 is an example diagram illustrating a more detailed implementation of a circuit including a switch driver and switch as discussed herein.

FIG. 3 is an example timing diagram illustrating states of signals associated with turn on of a respective main switch as discussed herein.

FIG. 4 is an example timing diagram illustrating states of signals associated with turn off of a respective main switch as discussed herein.

FIG. 5 is an example timing diagram illustrating states of signals associated with operation of a main switch as discussed herein.

FIG. 6 is an example timing diagram illustrating states of signals associated with operation of a main switch as discussed herein.

FIG. 7 is an example method associated with operation of switch driver circuitry as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

As further discussed herein, an apparatus (such as circuit, hardware, etc.) can be configured to include: a first input operative to receive a first control signal indicating how to control a main switch; switch driver circuitry operative to convert the first control signal into a second control signal; and an output operative to output the second control signal to the main switch, the second control signal including first current supplied from a first current source of the switch driver circuitry to the main switch, a magnitude of the first current varying based on a voltage magnitude of the second control signal.

In one example, the main switch is a gallium nitride field effect transistor (a.k.a., GaN FET). To maintain activation of the main switch as indicated by a received control signal, the switch driver circuitry needs to continuously drive the gate node of the main switch to keep it in an ON-state. It is desirable to prevent so-called overcharging of gate node such as via excessive drive of current to the gate node because this wastes power, especially when the main switch is repeatedly turned on and off at a high rate. For example, there may be a high power cost to turn on a respective switch. The switch driver circuitry as discussed herein provides more efficient use of power to activate the respective main switch and keep it in an ON-state in accordance with the received control signal.

More specifically, as further discussed herein, during a condition in which the received control signal indicates to activate the main switch to an ON-state, the switch driver circuitry provides (via the second control signal) the first current to the gate node of the main switch. This first current can be configured to be sufficiently high at the beginning of the on-time signal and taper as a magnitude of the control signal applied to the gate node of the main switch increases. As further discussed herein, the switch driver circuitry can be configured to include a second current source that simultaneously provides second current to the gate node of the main switch during a time duration in which the first control signal indicates to activate the main switch. Thus, initially, both the first current source and the second current source can be configured to supply current to the gate node of the main switch to activate it to the on state. Subsequent to the initial activation, and after a first portion of a respective on-time as indicated by the control signal, the first current source can be deactivated (first current reduced to substantially zero) and the second current source continues to supply appropriate current to the gate node of the main switch to maintain it in the ON-state. In such an instance, the first current source as discussed herein provides a temporary boost to activate the main switch to the ON-state but is turned off when it is no longer needed because the second current source supplies the appropriate current to maintain the switch to the ON-state.

Examples herein include optimization of switching loss to turn-on a respective main switch (130) by minimizing Gate overcharging of the corresponding gate of the main switch. Techniques as discussed herein may include implementing one or more trimming operations that substantially equalize the turn on dynamic behavior of different RDSON classes independent of GaN and C11HV process variations. The turn on path as described herein may be implemented by an NMOS driving switch (such as N-type field effect transistor 131-1) that has a trimmable self turn-off behavior soon after initial activation. Conventional solutions such as those using RC network may overcharge the GaN gate, like the RC network, and others may rely solely on the reaction time of a respective driver circuitry sensing the GaN power switch Vgs to minimize gate overcharging.

A main switch (130) activation may be achieved by an NMOS switch (131-1) that self-turns off when the gate voltage Vgate of the GaN switch increases. This self-turn off threshold can be programmable in production to compensate GAN and C11HV process variations, and also can equalize the dynamic behavior for different RDSON classes.

Thus, the present disclosure may include switch driver that reduces the turn on switching loss by minimizing Gate overcharge to a respective main switch (130). The turn on speed (and activating the main switch) is programmable by an external RDD resistor, and the amount of charges injected into the gate node of the main switch (130) is programmable by trimming voltages such as the VDD_HSDRV voltage. This VDD_HSDRV voltage can be trimmed to calibrate the HSNMOS self-turn off behavior and control the amount of charge injected into the GaN GIT gate compensating C11HV and GaN process variations. These calibrations can be achieved for all RDSON classes from 500 mOhm to 55 mOhm. This calibration (trimming) may be performed by trimming the VDD_HSDRV (117) in order that a chosen predefined minimum current is flowing into the gate node of the main switch (130).

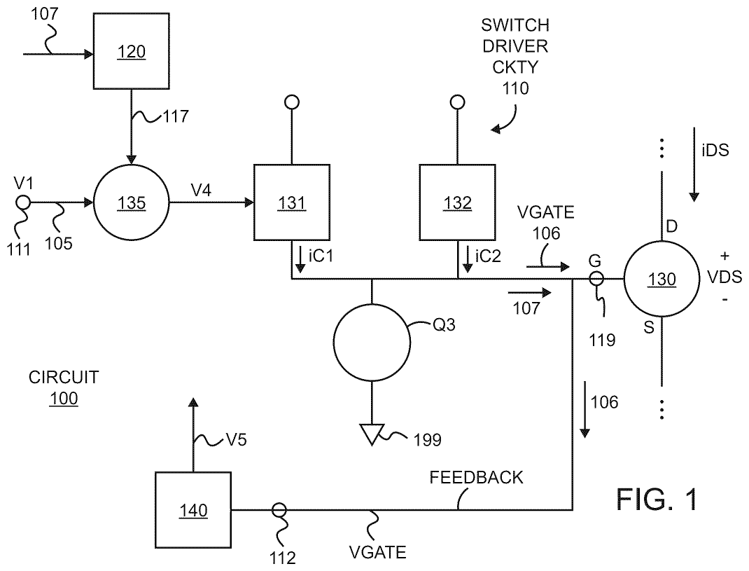

Now, more specifically, FIG. 1 is an example diagram of a circuit as described herein.

In this general example, the circuit 100 includes switch driver circuitry 110, trimmable voltage source 120, monitor 140, and main switch 130. The switch driver circuitry 110 can be configured to include current source 131, current source 132, switch 135, and switch 137.

In general, as further discussed herein, the switch driver circuitry 110 receives the corresponding control signal 105 at the input 111. The switch driver circuitry 110 receives the input voltage 121 (a.k.a., V9) from the trimmable voltage source 120 at the input 117. During operation, the switch driver circuitry 110 converts the received control signal 105 into the control signal 106 used to drive the gate node G of the main switch 130.

The control signal 106 (a.k.a., Vgate) controls the main switch 130 between an ON-state and an OFF-state depending upon the magnitude of the voltage associated with the control signal 106 or the magnitude of the corresponding current 107 supplied to the gate node G of the main switch 130.

In one example, the main switch 130 is a gallium arsenide (GaN) field effect transistor including a respective gate node G, a drain node D, and a source node S. The main switch 130 may require a minimum amount of current supplied to its gate node G in order to maintain the main switch 130 in an ON-state (e.g., where the ON-state is a low impedance path or Rdson between the drain node D of the main switch 130 and the source node S of the main switch 130).

When supplying sufficient current to the gate node G of the main switch 130, a magnitude of the voltage at the gate node of the main switch 130 may raise to any suitable voltage such as around 3 volts or other magnitude.

When no current (such as current iGATE=zero) is applied to the gate node of the main switch 130 and the voltage associated with the control signal 106 is substantially zero, the main switch 130 is deactivated (off state). In the off state, there is a high impedance path between the drain node of the main switch 130 and the source node of the main switch 130.

Accordingly, switch drive circuitry 110 as discussed herein can be configured to include: a first input 111 operative to receive a first control signal 105 (V1) indicating how to control the main switch 130. The switch driver circuitry 110 is configured to convert the first control signal 105 into the control signal 106. The output 119 of the switch driver circuitry 110 outputs the second control signal 106 to the gate node G of the main switch 130. The control signal 106 can be configured to include first current iC1 supplied from a first current source 131 of the switch driver circuitry 110 to the main switch 130. As further discussed herein, a magnitude of the first current iC1 can be configured to vary based on a voltage magnitude of the second control signal 106.

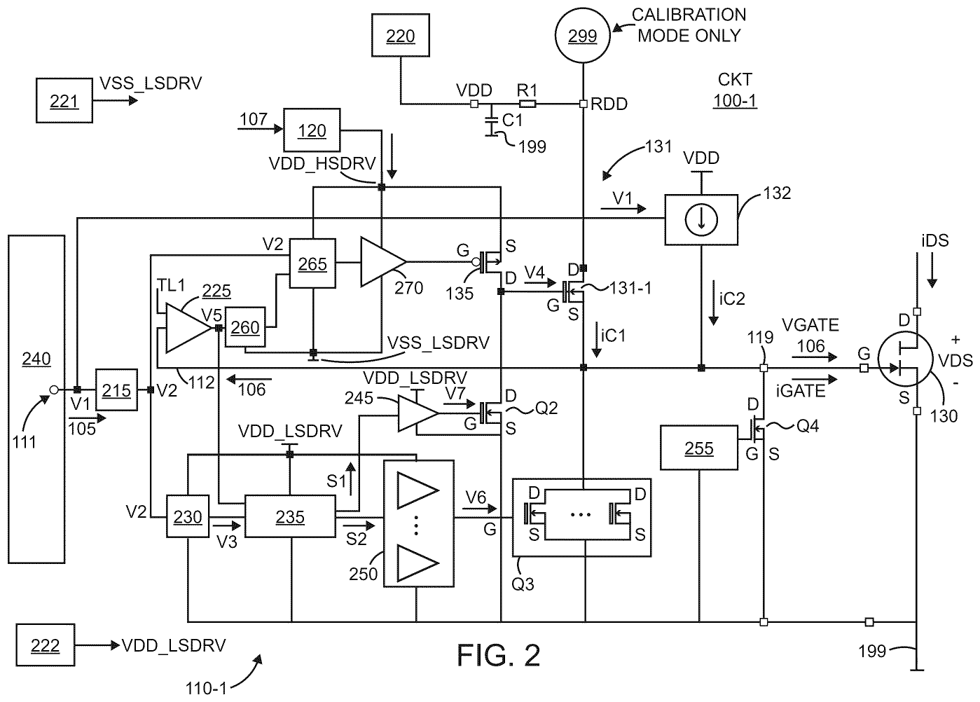

As further discussed herein, the first current source 131 may be or include a field effect transistor including a source node operative to output the first current iC1 to the gate node of the main switch 130. A supply of the first current iC1 from the source node of the current source 131 (such as a field effect transistor) to the gate node of the main switch 130 can be configured to reduce a magnitude of the first current iC1 over time. For example, the magnitude of the first current iC1 can be configured to decrease over time. In one example, the current source 131 (such as field effect transistor) is an HSNMOS (High Side NMOS) device that operates in a saturation mode. The reduction in current iC1 is due to HSNMOS IDSAT (drain to source saturation) reduction. In one example, IDSAT is the measured drain current with the device 131 biased in the saturation region. As further shown in FIG. 2, the RDS on resistance between the drain node of the first current source 131 (such as field effect transistor 131-1) and the source node of the current source 131 (such as field effect transistor 131-1) increases in response to a decrease in a gate-to-source voltage between a gate node of the field effect transistor and the source node of the field effect transistor. The decrease in the drain to source voltage (DS) associated with current source 131 (such as field effect transistor 131-1) may occur in response to an increase in the voltage magnitude of the second control signal 106 over time.

Referring again to FIG. 1, as shown, the circuit 100 as discussed herein can be configured to include a second current source 132 operative to produce second current iC2 (hold current to activate the switch 130, which may be trimmable). The second current source 132 may be disposed in parallel with the first current source 131.

The second control signal 106 can be configured to include a combination of the first current iC1 supplied by the current source 131 and the second current iC2 supplied by the current source 132.

As previously discussed, the second control signal 106 (such as generated via the current source 131 and current source 132) may be applied to a gate node G of the main switch 130 to control ON-OFF states of the main switch 130. The first control signal 105 may indicate to activate the main switch 130 for a time duration X, where X is any suitable value. In such an instance, the first current source 131 can be configured to: i) supply the first current iC1 to the gate node G of the main switch 130 for a first portion of the time duration X, and ii) discontinue supply of the first current iC1 to the gate node G of the main switch 130 for a second portion of the time duration X. As further discussed herein, the second portion may follow the first portion.

Additionally, the second current source 132 can be configured to supply the second current iC2 to the gate node of the main switch 130 for both the first portion of the time duration and the second portion of the time duration X. An output of the second control signal 106 for the time duration X to the gate node G of the main switch 130 can be configured to maintain the main switch 130 in an ON-state for the time duration X. A magnitude of the first current iC1 at an end of the first portion of the time duration X can be configured to maintain or help maintain the main switch 130 to an ON-state.

As further shown, the switch driver circuitry 110 can be configured to include the monitor 140. The monitor 140 can be configured to monitor a magnitude control signal 106. Subsequent to the first portion of the time duration X, the monitor circuit 140 can be configured to generate the control signal V5 to deactivate the current source 131.

FIG. 2 is an example diagram illustrating a more detailed implementation of a power supply as described herein.

In this example, the circuitry 100-1 (such as an instantiation of the circuitry 100) includes switch driver circuitry 110-1 (such as instantiation of the switch driver circuitry 110), controller 240, and the main switch 130.

Circuitry 100-1 further includes the power supply 220 operable to generate the voltage Vdd powering any of the components as discussed herein such as including the switch driver circuitry 110-1; power supply 221 is operative to produce the voltage VSS_HSDRV (in one example, VSS_HSDRV is a floating GND (VSS) domain for the High-side driver circuitry) used by the switch driver circuitry 110-1; and power supply 222 is operative to produce the voltage VDD_LSDRV used to power circuitry such as level shifter 230, driver circuitry 235, driver circuitry 250, etc., associated with the switch driver circuitry 110-1.

As shown, the switch driver circuitry 110-1 includes the level shifter 215, level shifter 230, level shifter 260, comparator 225, level shifter 260, level shifter 265 , , , driver 270, switch 135, current source 131 (such as including capacitor C1, resistor R1 in series with the switch 131-1), current source 132 (supplying current iC2), driver 235, driver 245, driver 250, switch Q2, switch Q3, charge pump 255, switch Q4, switch 131-1, and resistor R1.

During operation, the controller 240 produces the control signal 105 (V1) to control operation of the main switch 130.

The controller 240 (such as a specific implementation of the controller 140) supplies the control signal 105 to the level shifter 215 as well as the current source 132. Setting of the control signal 105 to a logic high level indicates that the main switch 130 should be activated to an ON-state. To this end, the logic high associated with control signal 105 causes the current source 132 to supply corresponding current iC2 to the gate node G of the main switch 130. Logic low of the control signal 105 causes the current source 132 to discontinue supplying current iC2 to the gate node G of the main switch 130.

As further discussed herein, transition of the control signal 105 from the logic low state to the logic high state also causes temporary activation of the current source 131 and corresponding switch 131-1 (such as a field effect transistor) in a manner as further discussed herein. The temporary activation of the current source 131 as opposed to continued activation of the current source 131 while the control signal 105 is set to a logic high helps to provide improved efficiency of operating the main switch 130. In other words, the novel operation as discussed herein reduces a magnitude of power required to activate the main switch 130 to an ON-state. After the switch 130 is appropriately activated to the ON-state, the current source supplying current iC1 is deactivated (switch 131-1 is set to an OFF-state preventing flow of current Ic1).

As further shown, the level shifter 215 converts the received control signal 105 (voltage V1) to the voltage V2 supplied to the level shifter 265 (such as driver logic at high side domain). Based on the voltage V2, the level shifter 265 drives the driver 270 to control operation of the switch 135. The output (V4) of the switch 135 controls operation of the switch 131-1 and corresponding current source 131.

Additionally, the level shifter 230 converts the received voltage V2 into the voltage V3 supplied to the driver 235 (such as driver logic at low side domain). Based on the voltage V3, the driver 235 controls operation of the driver 245 via signal S1 and the driver 250 the signal S2.

For example, based upon the received signal S1 from the driver 235, the driver 245 produces the control signal V7 supplied to the gate node of switch Q2. Based upon the received signal S2 from the driver 235, the driver 250 produces the control signal V6 supplied to the switch circuitry Q3. Switch circuitry Q3 (one or more transistors as driven by the driver 250) controls pulldown of the gate node G of the switch 130 to the reference potential 199 (reference voltage). Pulldown of the gate node G2 (switch circuitry Q3 activated to an ON-state) the reference voltage 199 turns off the switch 130.

In general, the current source 131 is temporarily activated to activate the switch 130 to an ON-state at or around the time of control signal 105 going from a low state to a high state. Switch 135 (on) and switch Q2 (off) enable temporary activation of the current source 131 and corresponding field effect transistor 131-1 when the control signal 105 is a logic high.

The switch circuitry Q3 may be activated in response to conditions in which the control signal 105 is set to a logic low state. Activation of the switch circuitry Q3 pulls the control signal 106 to a logic low (such as reference potential 199), deactivating the switch 130.

It is further noted that the combination of the charge pump 255 and the switch Q4 ensure that the switch 130 is set to an OFF-state upon power up of the different power supplies (such as Vdd, etc.) as shown in FIG. 2. For example, the switch Q4 is set to an ON-state during startup conditions in which the power supply voltages in FIG. 2 are ramped up to the appropriate level. After the power supplies reach the appropriate voltage levels, the charge pump 255 supplies control input to the gate node of switch Q4 to deactivate the switch Q4 to an OFF-state.

In yet further examples as discussed herein, the first current source 131 may be or include a field effect transistor (switch 131-1) operative to control/supply the first current iC1 from a source node S of the field effect transistor 131-1 to a gate node G of the main switch 130. The first current iC1 (when control signal 105 is set to a logic high) supplied by the field effect transistor to the gate node G of the main switch 130 increases the voltage magnitude (a.k.a. Vgate) of the second control signal 106 supplied to the gate node G of the main switch 130.

Note that the field effect transistor 131-1 may be an N-type field effect transistor. The switch 135 may be a P-type field effect transistor or other suitable entity.

The increase in the voltage magnitude of the second control signal 106 (or signal Vgate) applied to the gate node G of the main switch 130 is operative to reduce a gate-to-source voltage between a gate node of the field effect transistor and the source node of the field effect transistor (see further timing diagrams). In other words, as discussed herein, the switch 131-1 may be initially activated with voltage V4 (such as a substantially fixed voltage) while the magnitude of the control signal 106 is a low voltage. As the current source 131 supplies the current iC1 to the switch 130, the voltage Vgate (control signal 106) increases causing a magnitude of the gate-to-source voltage of the switch 131-1 to decrease. The decrease in the gate to source voltage (V4-Vgate as shown in timing diagram 310) of the switch 131-1 increases a resistance between a drain node D of the switch 131-1 and the source node S of the switch 131-1, thus reducing the magnitude of the first current iC1 supplied from the source S of the field effect transistor 131-1 (and corresponding current source 131) to the gate node of the main switch 130. Thus, initially the current iC1 supplied by the current source 131 is high as limited by the resistor R1 but the magnitude of current iC1 reduces over time.

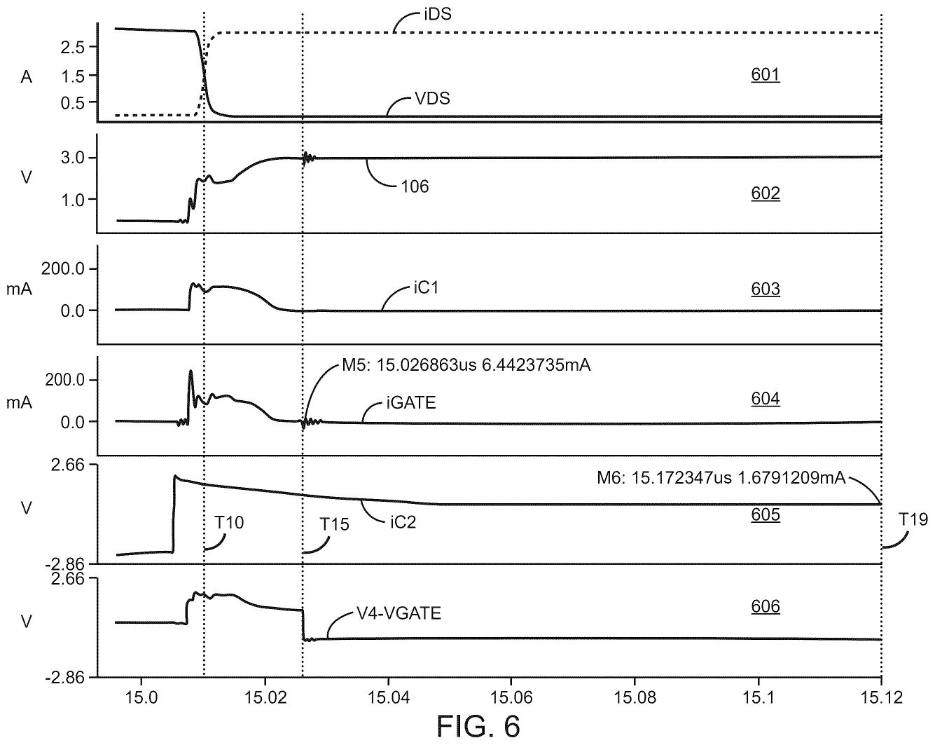

An example of a decrease in a magnitude of the current iC1 supplied by the current source 131 is shown in FIG. 6. For example, just prior to time T10, the switch 131-1 is activated to an ON-state resulting in conveyance of the current iC1 (starting in a magnitude of Vdd/R1) through the switch 131-1 to the gate node G of the main switch 130. Between time T10 and time T15, as the magnitude of the gate voltage Vgate increases, the magnitude of the current iC1 supplied by the switch 131-1 to the gate node of the main switch decreases (self-shutoff). Eventually, at or around time T15, as further discussed herein, the switch 131-1 is deactivated to an off state and the current iC1 is substantially zero.

Referring again to FIG. 2, as previously discussed, the main switch 130 can be implemented and/or fabricated in any suitable manner. In one example, the main switch 130 may be fabricated from Gallium Nitride (GaN).

In a further example, to activate the switch 132 to an ON-state, a certain amount of continuous current is supplied to the gate node G. The current iGATE received at the gate node G of the switch 130 flows to the source node S of the switch 130 to the reference potential 199. In one example, iGATE=iC1+iC2.

Yet further examples as discussed herein include implementation of the circuitry 100 or circuitry 100-1 (such as apparatus, hardware, device, etc.) to include: a second input 112 to receive feedback (such as voltage Vgate) tracking (or indicating) the voltage magnitude of the second control signal 106. In other words, the monitor 140-1 can be configured to receive and monitor the magnitude of the control signal 106 itself or monitor a derivative signal of the control signal 106 driving the gate node G of the main switch 130. As further discussed below, the purpose of monitoring the control signal 106 is to determine when to completely shut off the switch 131-1.

More specifically, as further shown, the circuit 100 can be configured to include a comparator 225 operative to compare the received feedback (control signal 106) to a threshold level. A corresponding signal generator is configured to terminate activation of the first current source 131 supplying the first current iC1 to the main switch 130 in response to detecting that the feedback (control signal 106 or Vgate) is crosses (such as falls below) a respective threshold level TL1.

In accordance with further examples as discussed herein, the circuit 100-1 can be configured to include a switch Q4 connected between a gate node G of the main switch 130 and a source node S of the main switch 130. As previously discussed, the switch Q4 is configured to short (providing a low impedance path) the gate node G of the main switch 130 to the source node S of the main switch 137 during startup of the switch driver circuitry 100 to prevent activation of the main switch 130 during the power supply startup.

Note that the first current source 131 can be configured in any suitable manner. In one example, the first current source 131 is or includes a first field effect transistor 131-1. The switch driver circuitry 110-1 can be further configured to include a second field effect transistor operative to convey a control voltage V4 (trimmed input voltage 117) received from a trimmable voltage source 120 to a control input (such as a gate node G) of the first field effect transistor 131-1 to activate the first field effect transistor 131-1. A magnitude of the control voltage V4 as derived from input voltage 117 and corresponding trimmable voltage source 120 may be selected (via an earlier trim process) to limit the magnitude of the first current iC1 supplied by the current source 131 to the main switch 130.

Additional details are discussed below. Note that the selected current limit (as implemented by the magnitude of the voltage V4 supplied by the trimmable voltage source) may be based on a magnitude of the first current iC1 required to drive a gate node G of the main switch 130 to activate the main switch 130 to an ON-state.

### Notable Characteristics of the Circuit 100-1:

turn on DV/DT of switch 130 may be programmable by an external RDD resistor
minimize gate overdrive of the main switch 130; field effect transistor 131-1 may be N-type
All RDSon classes provide similar switching performance; VDD_HSDRV is trimmable
HSNMOS switch (131-1) implements a self-turn off behavior during turn on as a magnitude of the voltage Vgate increases while the voltage V4 is static
hold current such as iC2 may be defined as minimum amount of current required to have short circuit protection for an Ids current value. In one example, the hold current iC2 is defined as the minimum constant current needed to keep the GaN switch (such as switch 130) in ON-state and have required Idsat.
all driver sub-circuits associated with the switch driver circuitry 110-1 may be referenced to VSSP! domain such as reference potential 199, GaN Kelvin source connection; GaN turn-off power loop is parasitic efficient
the pulse width modulation (control signal 105) may be received from the VSS! domain and may be shifted up to VDD_HSDRV domain and then shifted down to VDD_LSDRV domain; provide ground bouncing robustness
GaN Vgs (or Vgate) may be monitored to turn off HSNMOS as soon as target GaN gate voltage is reached
24 volt depletion to keep GaN switched off before power up. Negative charge pump 255 keeps the depletion off after power up.

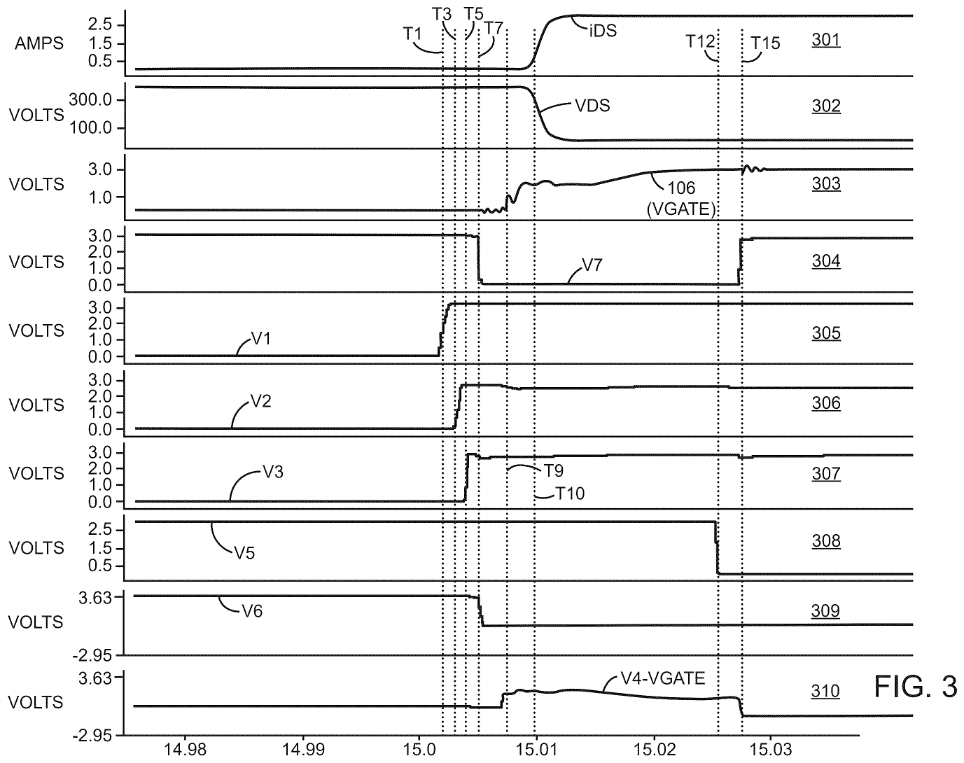

FIG. 3 is an example timing diagram illustrating states of signals associated with turn on of a respective main switch as discussed herein.

In this example, the controller 240 generates the transition of control signal 105 (a.k.a., V1) from a logic low to a logic high at time T1 as shown in timing diagram 305. This corresponds to a condition of the controller 240 generating a respective control signal 105 to activate the switch 130.

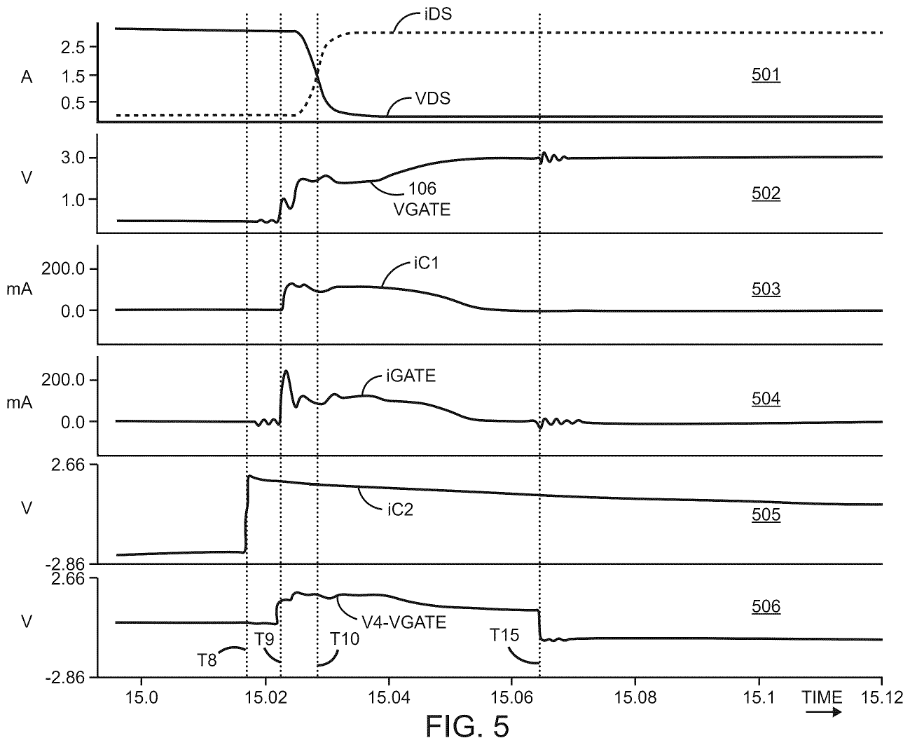

The transition of the control signal 105 from a logic low to the logic high state at or around time T1 causes the current source 132 to supply corresponding current iC2 to the gate node of the switch 130 starting around time T8 (see FIG. 5). In other words, as previously discussed, activation of the current source 132 is based upon the control signal 105.

Referring again to FIG. 3, the transition of the control signal 105 to the logic high state causes level shifter 250 to produce the corresponding signal V2 (timing diagram 306) to a logic high state at or around time T3.

Thus, in response to the low to high transition of signal V1 at or around time T1, the signal V2 transitions from low to high state at time T3. The combination of the level shifter 265 and the driver 270 receive the signal V2 and, in response to the signal V2 being a logic high, the combination of the driver circuit 265 and the driver 270 activate the switch 135 via the output of the driver 270 to gate node G of the switch 135. In such an instance, the activation of the switch 135 conveys the voltage 117 from the trimmable voltage source 120 (as voltage V4) to the gate node of switch 131-1.

While the switch 135 is in the ON-state, the voltage V4 outputted from the drain node of the switch 135 to the gate node of the switch 131-1 is substantially equal to the voltage 117 supplied by the trimmable voltage source 120. As previously discussed, the control signal 107 controls the magnitude of the voltage 117 outputted from the trimmable voltage source 120.

In one example, the magnitude of the gate voltage Vgate applied to the gate node of the main switch 130 may be initially zero prior to transition of the control signal 105 from the logic low state to the logic high state. This is because, prior to time T1, the switch Q3 is activated to an ON-state to control the magnitude of the voltage Vgate to the reference potential 199.

As previously discussed, the switch 131-1 and corresponding current source 131 is activated at around time T9. Additionally, the magnitude of the voltage at the gate node G of switch 131-1 is voltage V4. In such an instance, the switch 131-1 is activated to the ON-state at or around time T9, causing flow of current iC1 from the voltage source 220 through the resistor R1 and switch 131-1 to the gate node G of the main switch 130. Thus, the current source 131 is activated at around time T9 to supply corresponding current iC1 to the gate node G of the switch 130 to activate the switch 130 to an ON-state.

As further shown as shown in timing diagram 306, transition of the voltage V2 to the logic high state and time T3 causes the level shifter 230 to produce the voltage V3 (see timing diagram 307) supplied to the driver 235. In such an instance, the driver 235 and the driver 245 produce the voltage V7 applied to the switch Q2. As shown in timing diagram 304, the voltage V7 transitions from a logic high to a logic low at or around time T7 in response to the control signal 105 activating the switch 130. The voltage V7 also transitions from a logic low to a logic high around time T15. Additionally, the voltage V6 transitions from a logic high to a logic low at or around time T7 as shown in timing diagram 309.

This deactivation of the switch Q2 at or around time T7 allows the switch 135 to supply the voltage 117 to the gate node of the switch 131-1 because the gate node of switch 131-1 is no longer shorted to the reference potential 199 via the activated switch Q3 at time T7.

As further shown in timing diagram 310, the gate to source voltage (V4-Vgate) associated switch 131-1 increases at or around time T9 based upon activation of the switch 131-1 (current source 131 activated via the voltage 117 applied through the switch 135 to the gate node of switch 131-1) and the current source 132. In other words, as previously discussed, supply of current iC1 and current iC2 between time T7 and time T15 increases the magnitude of the voltage at the gate node G of the switch 130, resulting in an increase in the magnitude of the Rds On resistance between the drain node D and the source node S of the switch 131-1 (as the gate to source voltage associated with the switch 131-1 decreases).

While both the current source 131 and the current source 132 are activated to supply current to the gate node of the main switch 130 (such as approximately between time T5 and time T15), the comparator 225 receives a respective feedback signal (such as voltage Vgate applied to the gate node of the switch 130) at the input 112 of the comparator 225. As shown in timing diagram 305, the comparator 225 detects that the voltage Vgate crosses a respective threshold level at or around time T12, resulting in the voltage signal V5 (timing diagram 308) transitioning from a logic high to a logic low. Such a transition of voltage V5 transitioning from the logic high state to logic low state causes deactivation of the switch 135 and activation of the switch Q2 (voltage V7 transitions from a logic low to a logic high at around time T15 to turn on switch Q2). Accordingly, the current source 131 and corresponding switch 131-1 are deactivated at around time T15.

Note that after time T15 as shown in timing diagram 305, even though the current source 131 and corresponding current iC1 are shut off, the control signal V1 indicates to continue maintaining the switch 130 to the ON-state. Even though the current source 131 and corresponding switch 131-1 are deactivated at time T15 and supply current iC1 drops to substantially zero, the current source 132 is still activated to supply current iC2 to the gate node of the main switch 130. The activation of the current source 131 and supply of corresponding current iC1 to the gate node between time T9 and time T15 (as a supplement to current iC1) provides a boost to initially turn on the main switch 130.

In one example, note that calibration of the trimmable voltage source 120 includes deactivating the current source 132 as well as corresponding comparator 225 so that the comparator 225 is unable to deactivate the corresponding signals controlling the switch 135 and the switch 131-1. Control signal 105 is set to the high state, causing activation of the switch 130. Additionally, the power source 299 is activated to apply power such as a voltage or current to the node RDD. Different settings of the power source 120 are checked (such as the activation of the switch 135 using different possible settings of the voltage 117) applied to the source node of switch 135. One of the different possible settings is chosen such that the selected magnitude of the voltage 117 results in activation of the switch 131-1 to an appropriate degree such that the switch 130 as an ON-state.

As previously discussed, the switch 135 in the active state conveys a magnitude of the voltage 117 to the gate node of the switch 131-1. Thus, calibration may include activating the switch 135 to apply the voltage 117 to the gate node of switch 131-1 while the power source 299 applies corresponding current through the switch 131-1 to the gate node of the main switch 130. The current iDS through the switch 130 is measured during the calibration tests. The magnitude of the voltage 117 is adjusted (such as via control signal 107) such that the switch 131-1 provides a desired magnitude (such as 3 milliamps or other suitable magnitude) of current iC1 from the power source 299 through the switch 131-1 to the gate node of the switch 130. The appropriate setting of a control signal 107 providing the desired magnitude of current iC1 is stored in a buffer of the circuit 100-1 and is then used in normal operation as shown in the timing diagrams (FIGS. 3 through 6).

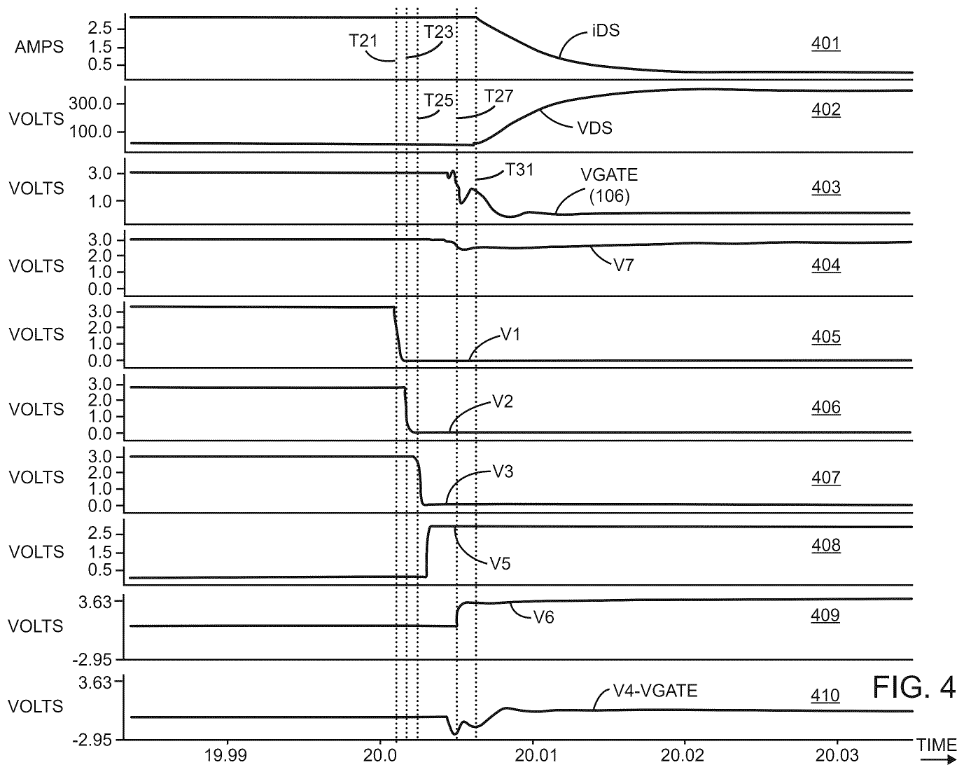

FIG. 4 is an example timing diagram illustrating states of signals associated with turn off of a respective main switch as discussed herein.

At time T21 (such as subsequent to time T15 as previously discussed) as shown in timing diagram 404, the controller 240 transitions the magnitude of the control signal 105 (V1) from a logic high state to a logic low state. This transition of the control signal 105 indicates to shut off the main switch 130.

In response to the transition of the control signal 105 at or around time T21, the level shifter 215 transitions the signal V2 from a logic high to a logic low at or around time T23. As further shown in timing diagram 404, the transition of the voltage V2 from the logic high to the logic low state causes the level shifter 230 to transition the voltage V3 from a logic high to a logic low state. This (V3 falling edge in timing diagram 407) in turn causes the driver 235 and corresponding driver 250 to transition the voltage V6 (timing diagram 409) from a logic low to a logic high state at time T27 as shown in timing diagram 409, resulting in activation of the switch Q3 at or around time T27. Activation of the switch Q3 at or around time T27 causes the voltage Vgate of the gate node G of the switch 130 to be pulled down to the reference potential 199. This deactivates the respective main switch 130 at or around time T31 as shown in timing diagram 401 and timing diagram 402. Accordingly, at or around time T31, as shown in timing diagram 401, the magnitude of the current iDS through the main switch 130 decreases to substantially 0 amperes or other suitable value. Additionally, at or around time T31, because the main switch 130 is deactivated to the OFF-state, as shown in timing diagram 402, the magnitude of the voltage Vds increases.

FIG. 5 is an example timing diagram illustrating states of signals associated with operation of a main switch as discussed herein.

As previously discussed, as shown further in timing diagram 505, transition of the control signal 105 from the logic low state to a logic high state causes the current source 132 to supply the current iC2 from the current source 132 to the gate node G of the switch 130 at or around time T8. As previously discussed, at or around T9, the activation of the switch 131-1 causes a respective flow of current iC1 through the current source 131 and corresponding switch 131-1 to the gate node G of the switch 130. Accordingly, the total current iGATE supplied by a combination of the current sources 131 and 132 peaks just after time T9.

Further, as previously discussed, the switch 130 transitions from the OFF-state to the ON-state at or around time T10. Just before time T15, the total magnitude of current iGATE supplied from the combination of both activated current sources 131 and is approximately 6.5 milliamps or other suitable value. Just after time T15, as shown in timing diagram 505, when the current source 131 is deactivated at or around time T15, the current source 132 supplies a current iC2 of around 3 milliamps to the gate node of the main switch 130.

FIG. 6 is an example timing diagram illustrating states of signals associated with operation of a main switch as discussed herein.

As shown in timing diagram 605, after the current source 131 is deactivated at or around time T15, a magnitude of the current iC2 (a.k.a., hold current) settles to around 1.7 milliamps or other suitable value at around time T19.

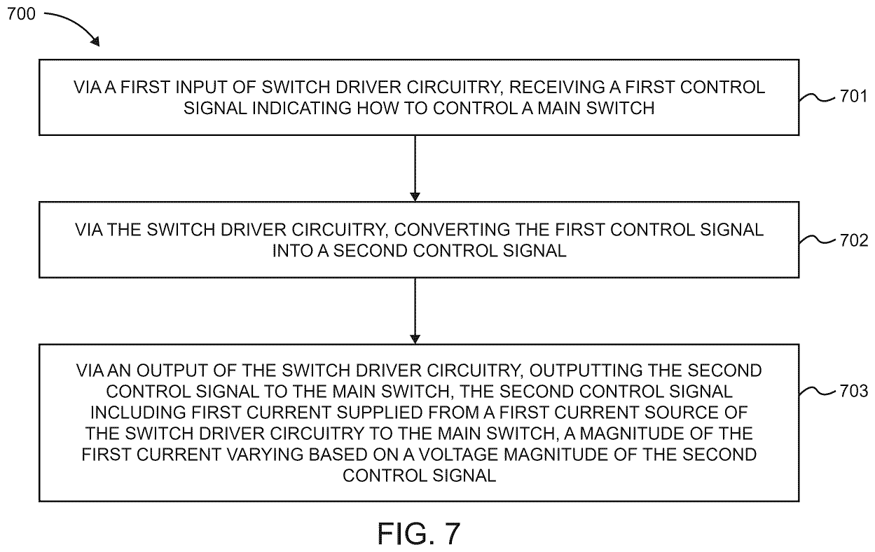

FIG. 7 is an example method associated with operation of switch driver circuitry as discussed herein.

In processing operation 710 of flowchart 700, via a first input 111, the switch driver circuitry 110 receives a first control signal 105 indicating how to control a main switch 130.

In processing operation 720, the switch driver circuitry 110-1 converts the control signal 105 (V1) into the control signal 106 (Vgate).

In processing operation 730, via an output 119, the switch driver circuitry 110 outputs the second control signal 106 and corresponding current iGATE to the gate G of the main switch 130. As previously discussed, the second control signal 106 can be configured to include temporary first current iC1 supplied from a current source 131 of the switch driver circuitry 110 to the gate node of the switch 130. Further, as previously discussed, a magnitude of the first current iC1 varies based on a voltage magnitude of the second control signal 106. In other words, initially, activation of the current source 131 and corresponding switch 131-1 causes the current iC1 to flow to the gate node G of the main switch 130. The flow of the current iC1 causes the voltage magnitude of the control signal 106 and voltage at the source node S of the switch 131-1 to increase, thereby reducing the gate-to-source voltage associated with the switch 131-1. Reduction in the gate-to-source voltage associated with the switch 131-1 advantageously reduces the magnitude of the current iC1 supplied by the current source 131 to the gate node of the switch 130 over the short window of time (time T9 to time T15) that the current source 131 is activated. Eventually, the magnitude of the control signal 106 increases above a threshold level as detected by the comparator 225, resulting in shutoff of the current source 131 and corresponding switch 131-1 while the current source 132 remains in an ON-state during the remaining portion of the time duration in which the control signal 105 is at a logic high level. Thus, the current source 131 provides a temporary boost in current supplied to the gate node of the switch 132 activate it. The current source 132 provides a sufficient magnitude of current iC2 to keep the switch 130 in the on state for the time duration when the control signal 105 is a logic high. For example, at initial activation of the switch 131-1 at or around time T9, the magnitude of the current iC1 is limited by the voltage VDD and the resistor R1. Just prior to time T 15, when the switch 131-1 is still activated, the magnitude of the current iC1 supplied by the current source 131 depends on the magnitude of the selected trimmed voltage 117.

Note again that techniques herein are well suited for use in circuit applications such as those implementing gate driver circuitry. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
a first input operative to receive a first control signal indicating how to control a main switch;
switch driver circuitry operative to convert the first control signal into a second control signal; and
an output operative to output the second control signal to the main switch, the second control signal including first current supplied from a first current source of the switch driver circuitry to the main switch, a magnitude of the first current varying based on a voltage magnitude of the second control signal.

2. The apparatus as in claim 1, wherein the first current source is a field effect transistor including a source node operative to output the first current to a gate node of the main switch.

3. The apparatus as in claim 2, wherein a supply of the first current from the source node of the field effect transistor to the gate node of the main switch is operative to reduce a magnitude of the first current over time; and
wherein the magnitude of the first current is operative to decrease over time, the first current being saturation current.

4. The apparatus as in claim 3, wherein the saturation current decreases over time in response to a decrease in a gate-to-source voltage between a gate node of the field effect transistor and the source node of the field effect transistor, the decrease occurring in response to an increase in the voltage magnitude of the second control signal over time.

5. The apparatus as in claim 1 further comprising:
a second current source operative to produce second current, the second current source disposed in parallel with the first current source, the second control signal derived based on a combination of the first current and the second current; and
wherein the second control signal is applied to a gate node of the main switch to control the main switch.

6. The apparatus as in claim 5, wherein the first control signal indicates to activate the main switch for a time duration; and
wherein the first current source is operative to: i) supply the first current to the gate node of the main switch for a first portion of the time duration, and ii) discontinue supply of the first current to the gate node of the main switch for a second portion of the time duration, the second portion following the first portion.

7. The apparatus as in claim 6, wherein the second current source is operative to supply the second current to the gate node of the main switch for both the first portion of the time duration and the second portion of the time duration; and
wherein output of the second control signal for the time duration to the gate node is operative to maintain the main switch in an ON-state for the time duration.

8. The apparatus as in claim 7, wherein a magnitude of the first current at an end of the first portion of the time duration is operative to maintain the main switch to an ON-state.

9. The apparatus as in claim 1, wherein the first current source is a field effect transistor operative to supply the first current from a source node of the field effect transistor to a gate node of the main switch; and
wherein the first current supplied by the field effect transistor to the gate node of the main switch increases the voltage magnitude of the second control signal supplied to the gate node of the main switch.

10. The apparatus as in claim 9, wherein the field effect transistor is an N-type field effect transistor.

11. The apparatus as in claim 9, wherein the increase in the voltage magnitude of the second control signal applied to the gate node of the main switch is operative to reduce a gate-to-source voltage between a gate node of the field effect transistor and the source node of the field effect transistor, the reduced gate-to-source voltage operative to reduce the magnitude of the first current supplied from the source node of the field effect transistor to the main switch.

12. The apparatus as in claim 1, wherein the main switch is fabricated from Gallium Nitride (GaN).

13. The apparatus as in claim 1 further comprising:
a second input operative to receive feedback tracking the voltage magnitude of the second control signal;
a comparator operative to compare the received feedback to a threshold level; and
a signal generator operative to terminate activation of the first current source supplying the first current to the main switch in response to detecting that the feedback is greater than the threshold level.

14. The apparatus as in claim 1 further comprising:
a first switch connected between a gate node of the main switch and a source node of the main switch, the first switch operative to short the gate node of the main switch to the source node of the main switch during startup of the switch driver circuitry to prevent activation of the main switch.

15. The apparatus as in claim 1, wherein the first current source is a first field effect transistor; and
wherein the switch driver circuitry further includes a second field effect transistor operative to convey a control voltage received from a voltage source to a gate input of the first field effect transistor to activate the first field effect transistor.

16. The apparatus as in claim 15, wherein a magnitude of the control voltage received from the voltage source is selected to limit the magnitude of the first current supplied by the first current source to the main switch.

17. The apparatus as in claim 16, wherein the limit is based on a magnitude of the first current required to drive a gate node of the main switch to activate the main switch to an ON-state.

18. A method comprising:
via a first input of switch driver circuitry, receiving a first control signal indicating how to control a main switch;
via the switch driver circuitry, converting the first control signal into a second control signal; and
via an output of the switch driver circuitry, outputting the second control signal to the main switch, the second control signal including first current supplied from a first current source of the switch driver circuitry to the main switch, a magnitude of the first current varying based on a voltage magnitude of the second control signal.

19. The method as in claim 18, wherein the first current source is a field effect transistor including a source node operative to output the first current to a gate node of the main switch; and
wherein outputting the second control signal to the main switch includes supplying the first current from the source node of the field effect transistor to the gate node of the main switch, the supply of the first current reducing a magnitude of the first current over time.

20. The method as in claim 18, wherein the first current source is a first field effect transistor; and
via a second field effect transistor of the switch driver circuitry, conveying a control voltage received from a trimmable voltage source to a control input of the first field effect transistor to activate the first field effect transistor; and
wherein a magnitude of the control voltage received from the trimmable voltage source is selected to limit the magnitude of the first current supplied by the first current source to a gate node of the main switch.
